(19) United States
(12) Patent Application Publication
(10) Pub. No.: US 2011/0099067 A1
(43) Pub. Date: Apr. 28, 2011

(54) DYNAMICALLY GENERATED INTERACTIVE ACCOUNT STATEMENT

(75) Inventors: John Cooper, Newark, DE (US); Justin McCord, Weddington, NC (US); Tom Boettger, Wilmington, DE (US); Mike Coyne, Smyrna, DE (US); Samantha Wallace, Hockessin, DE (US); Rex Oberg, Chadds Ford, PA (US)

(73) Assignee: BANK OF AMERICA CORPORATION, Charlotte, NC (US)

(21) Appl. No.: 12/914,421

(22) Filed: Oct. 28, 2010

Related U.S. Application Data
(60) Provisional application No. 61/255,727, filed on Oct. 28, 2009.

(51) Int. Cl. G06Q 30/00; G06Q 40/00

(52) U.S. Cl. 705/14.53

(57) ABSTRACT

Computer readable media, apparatuses, and methods may include analyzing account information for an account with a financial institution, where the account is associated with a first customer of the financial institution, and wherein the account information comprises a plurality of purchases made by the first customer using the account, selecting a subset of marketing offers from a plurality of available marketing offers, based on the plurality of purchases, generating an interactive account statement for the customer, said account statement comprising the account information and the subset of marketing offers, wherein each marketing offer in the subset of marketing offers is hyperlinked in the interactive account statement to additional information corresponding to that offer, and sending the interactive account statement to a client device associated with the customer.

### CROSS REFERENCE TO RELATED APPLICATIONS

This application claims the benefit of U.S. Provisional Patent Application No. 61/255,727, filed Oct. 28, 2009, the contents of which are expressly incorporated herein by reference in their entirety.

### BACKGROUND

Currently, the banking industry mails account statements to customers in paper form. An account statement may inform an account holder of transactions, such as purchases, debits, and credits, made using their account over a billing cycle. Advertisements may be included in an envelope that contains the account statement, but the included advertisements are not individually tailored to interests of any particular account holder. Rather, advertisements are generalized for account holders as a group. Large subsets of account holders in the group may receive advertisements that are of no interest. Even if some are interested in an advertisement, the account holder must take additional steps to act on the advertised offer, such as making a phone call, going to a store, etc. Interested account holders often may forget to act on their interest because of these extra steps. Moreover, mailing paper statements have environmental and economical costs.

Some banks send account statements in virtual paper form, e.g., as a static PDF file built from a template that, except for individual account information, provides the same advertising and solicitations to each customer receiving a PDF statement as every other customer. These virtual paper statements thus have many of the same drawbacks and limitations of paper statements.

### BRIEF SUMMARY

In light of the foregoing background, the following presents a simplified summary of the present disclosure in order to provide a basic understanding of some aspects of the disclosure. This summary is not an extensive overview. It is not intended to identify key or critical elements or to delineate scope. The following summary merely presents some concepts in a simplified form as a prelude to the more detailed description provided below.

Aspects of the disclosure address one or more of the issues mentioned above by disclosing methods, computer readable media, and apparatuses for providing a dynamically generated interactive account statement.

With aspects of the disclosure, computer readable media, apparatuses, and methods may include analyzing account information for an account with a financial institution, where the account is associated with a first customer of the financial institution, and wherein the account information comprises a plurality of purchases made by the first customer using the account, selecting a subset of marketing offers from a plurality of available marketing offers, based on the plurality of purchases, generating an interactive account statement for the customer, said account statement comprising the account information and the subset of marketing offers, wherein each marketing offer in the subset of marketing offers is hyperlinked in the interactive account statement to additional information corresponding to that offer, and sending the interactive account statement to a client device associated with the customer.

With other aspects of the disclosure, systems and methods may include receiving an interactive account statement message comprising an interactive account statement at a client device; prompting, by the client device, a user to input authentication information in response to the user instructing the client device to open the interactive account statement, communicating an authentication request comprising the authentication information to a computer server, receiving an authentication confirmation from the computer server, and presenting the interactive account statement to the user.

Aspects of the disclosure may be provided in one or more computer-readable media having computer-executable instructions that, when executed, cause one or more processors to perform one or more of the process steps described herein. In some embodiments, aspects of the example embodiments may be implemented on a computer-readable medium, for example, by storing computer-executable instructions or modules, or by utilizing computer-readable data structures. Of course, the methods and systems of the embodiments may also include other additional elements, steps, computer-executable instructions, or computer-readable data structures. For example, one skilled in the art will recognize that the various modules described herein may be implemented using programming code (e.g., C++, C, Java, etc.) and be associated with a processor on a computing device that may execute the module.

### BRIEF DESCRIPTION OF THE DRAWINGS

The present disclosure is illustrated by way of example and is not limited in the accompanying figures in which like reference numerals indicate similar elements and in which:

FIG. 1 illustrates an example block diagram of a server in communication system for providing a dynamically generated interactive account statement to a client device.

FIGS. 2A-B illustrates an example of a dynamically generated interactive account statement.

FIG. 3 illustrates messages communicated between the server and the client device.

FIG. 4 illustrates an interface for presenting a dynamically generated interactive account statement message.

FIGS. 5-7 illustrate example graphical user interfaces prompting a user to input authentication information.

FIG. 8 illustrates an example bill payment website.

FIG. 9 illustrates an example website providing access to previous dynamically generated interactive account statements.

FIG. 10 illustrates an example balance transfer website.

FIG. 11 illustrates an example flow diagram for generating a dynamically generated interactive account statement.

FIG. 12 illustrates an example flow diagram for processing a transaction using a dynamically generated interactive account statement.

### DETAILED DESCRIPTION

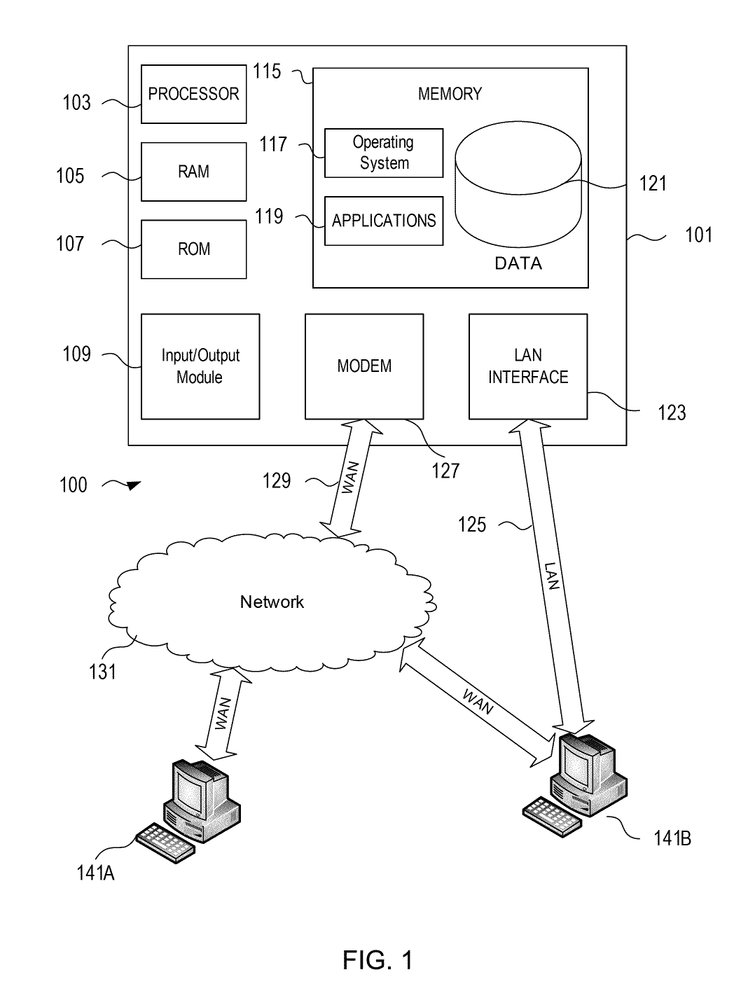

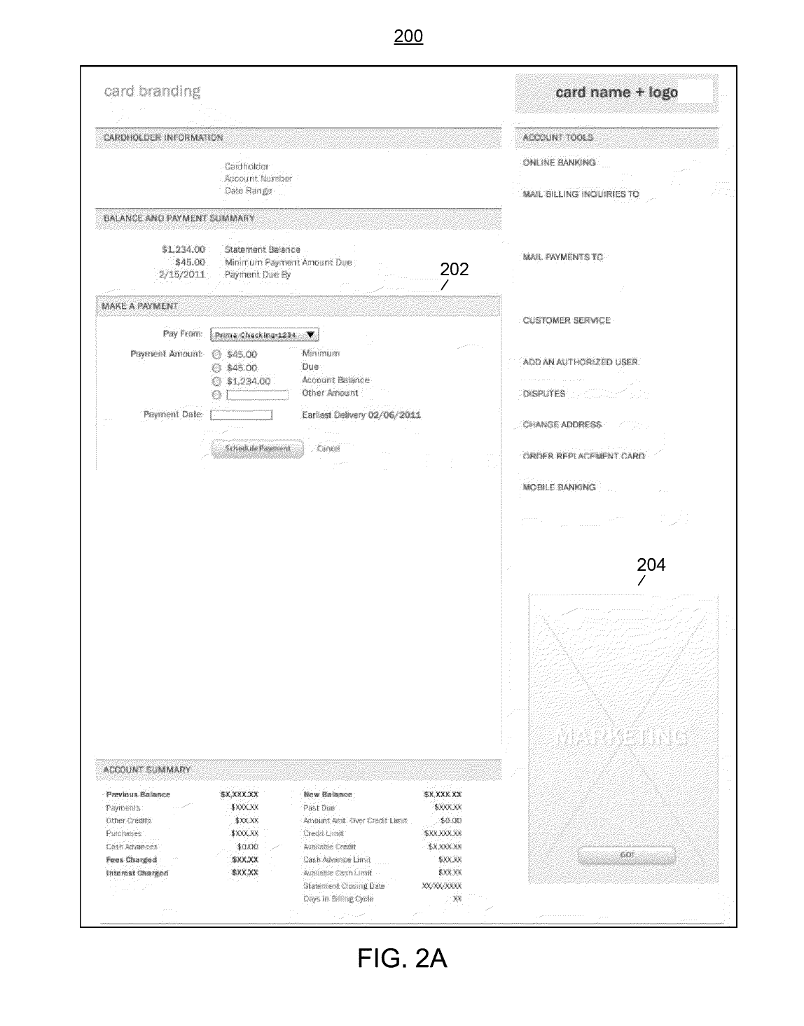

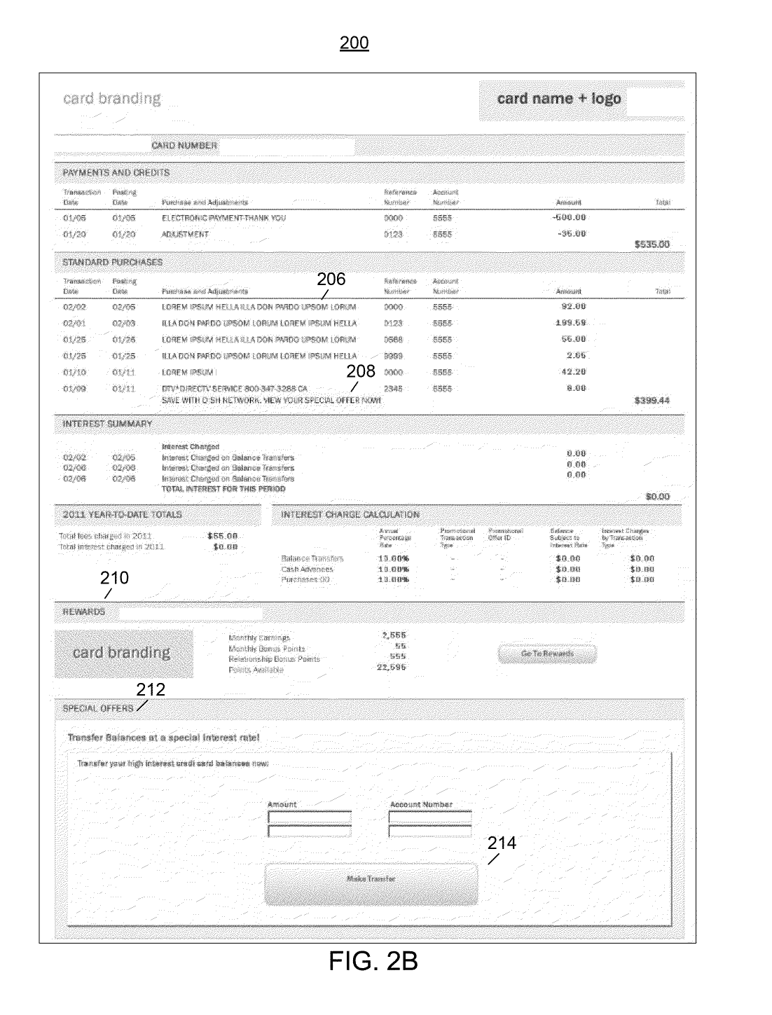

FIG. 1 illustrates an example block diagram of a computer server 101 in a communication system 100 for providing a dynamically generated interactive account (DGAI) statement 200 to a client device 141, and FIGS. 2A-B illustrates an example of the DGAI statement 200. The DGAI statement 200 may be, for example, an electronic bank statement for a user account (e.g., credit card account, savings account, checking account, etc.) provided by a financial institution (e.g., bank, credit card company, etc.) The DGAI statement 200 may identify the user's account information (e.g., name, address, account number), payment information (e.g., amount due, minimum payment, etc.), provide an account activity summary during a previous billing cycle (e.g., purchases last month), and otherwise may be compliant with the Unfair and Deceptive Practices Acts (UDAP) and Credit Card Accountability Responsibility and Disclosure (CARD) Act.

The DGAI statement 200 may also permit a user to conduct transactions. A user may fill in information in the DGAI statement 200 to cause the client device 141 to interact with the computer server 101 to perform a desired transaction, as described in further detail below. The DGAI statement 200 may include links, such as, for example, hyperlinks for user selection containing a uniform resource locator (URL) instructing the client device 141 to request a webpage to obtain additional information on a desired transaction or to sign up for a desired transaction. Paper suppressed customers may thus be able to take advantage of marketing offers similar to paper-based statements, which can include inserts, bangtails and balance transfer offers. The below example embodiments describe a financial institution providing the DGAI statement 200, but entities other than a financial institution may provide a DGAI statement 200.

Referring to FIG. 1, the computer server 101 may have a processor 103 for controlling its overall operation and its associated components, including RAM 105, ROM 107, input/output module (I/O) 109, and memory 115. The computer server 101 may operate in a networked environment supporting connections to one or more remote computers, such as client devices 141A and 141B. The client devices 141A and 141B may be personal computers or servers that include many or all of the elements described in the computer server 101. Computer server 101 and/or client devices 141A and/or 141B may also be mobile terminals including various other components, such as a battery, speaker, and antennas. Processor 103 and its associated components may run a series of computer-readable instructions to generate the DGAI statement 200 and to perform account transactions using the DGAI statement 200.

Input/Output (I/O) 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for performing various functions. For example, memory 115 may store software such as an operating system 117, application programs 119, and an associated database 121.

The network connections depicted in FIG. 1 include a local area network (LAN) 125 and a wide area network (WAN) 129, but may also include other networks. When used in a LAN networking environment, the computer server 101 is connected to the LAN 125 through a network interface or adapter 123. When used in a WAN networking environment, the server 101 may include a modem 127 or other means for establishing communications over the WAN 129, such as the Internet. It will be appreciated that the network connections shown are illustrative and other means of establishing a communications link between the computers may be used. The existence of any of various well-known protocols such as TCP/IP, Ethernet, FTP, HTTP and the like is presumed.

The operations of computer devices and systems shown in FIG. 1 may be controlled by computer-executable instructions stored on computer-readable storage medium. Embodiments also may take the form of electronic hardware, computer software, firmware, including object and/or source code, and/or combinations thereof. Embodiments may be stored on computer-readable media installed on, deployed by, resident on, invoked by and/or used by one or more data processors (e.g., 64-bit processor), controllers, computers, clients, servers, gateways, networks of computers, and/or any combinations thereof. The computers, servers, gateways, may have one or more controllers configured to execute instructions embodied as computer software. Examples of computer readable media include read only memory (ROM), random access memory (RAM), a compact disk (CD), a hard disk, or other storage device configured to store computer-executable instructions.

Initially, a user of the client device 141 may enroll to periodically receive the DGAI statement 200 instead of, or in addition to, a paper statement. For example, the user may use the client device 141 to access a webpage of the server 101 to open an account with a financial institution and sign up to receive the DGAI statement 200. When signing up, the user may select identifier information, such as, but not limited to, a username and password, to uniquely identify the user. The identifier information may also include an image, such as used during SITEKEY™ authentication provided by BANK OF AMERICA™ Corporation of Charlotte, N.C. Techniques other than SITEKEY™ may also be used for user authentication.

Once enrolled, the computer server 101 may communicate an enrollment message to the client device 141 to determine whether the client device 141 can properly open the DGAI statement 200. The client device 141 may include acceptance information in the format of the DGAI statement 200 to ensure that the client device 141 can properly receive and display the DGAI statement 200. The user may input information from the acceptance information to the client device 141 for communication to the computer server 101, thereby verifying that the client device 141 can properly display the DGAI statement 200. For example, the acceptance information may be an image depicting a sequence of letters and/or numbers.

Prior to generating the DGAI statement 200, the computer server 101 may retrieve purchase history information for a user account and may identify available marketing offers for inclusion in the DGAI statement 200 based on the purchase history. The purchase history information may be transactions, payments, or other activity on the user account in a predetermined amount of time (e.g., preceding month).

The computer server 101 may identify marketing offers based on recent purchases using the account, demographic information, advertiser requirements, or any combination thereof. In an example embodiment, the financial institution may sell advertising space within the DGAI statement 200 to advertisers. The computer server 101 may host a webpage where advertisers may input advertisements to include in the DGAI statement 200. The computer server 101 may store an expiration date associated with each marketing offer and may remove any stored offers that have expired.

The computer server 101 may analyze recent purchases made using the user account to identify advertisements for products related to the recent purchases. For example, the computer server 101 may identify a recent purchase of an airline ticket and include an advertisement related to new luggage in the DGAI statement 200 or advertisements for merchants at the flight destination. In another example, the computer server 101 may analyze recent purchases to determine that the user is shopping at a first store or purchasing services from a first provider, and may include offers for a competitor's store, service, or product in the DGAI statement 200. The computer server 101 may also identify any cross-offers from the financial institution to include in the DGAI statement 200.

The server 101 may statistically analyze the purchases to identify trends. For instance, the server 101 may process a user's purchase history to identify that the user purchases a product at semi-regular periodic intervals (e.g., renews a magazine subscription every year, shops at a greenhouse every march, etc.). The server 101 may provide advertisers with access to information to permit them to purchase advertisements when a current time precedes a next instance of the semi-regular periodic interval. For instance, a user may purchase a product once every June and December, so an advertiser of a competitive product may purchase advertising space included in a DGAI statement 200 sent out in May and November.

The server 101 may apply a weighting function to the purchase history to give greater consideration to certain purchases. The weighting function may, for example, weight newer purchases higher than older purchases if a user is likely to be a repeat customer, and may weight purchases based on time of year (e.g., more likely to purchase snow removal equipment in the winter, flowers in the spring, etc.). In one example, the server 101 may applying a weighting function that ignores all purchases made after a threshold amount of time in the past are unlikely to be repeated (e.g., purchase at a store 1 year ago unlikely to be repeated). Also, the server 101 may analyze the purchase history information to identify regular customers of a first provider who have switched to a competitor, to permit the first provider to include an offer or other incentive to remain a customer.

The computer server 101 may identify any advertiser requirements when selecting offers to include in the DGAI statement 200. Advertiser requirements can include paying a premium for certain types of customers (e.g., customers that recently purchased a certain product or service, a competitor's product or service, within a certain demographic, etc.). The computer server 101 may then generate a DGAI statement 200 including one or more marketing offers for communication to the client device 141.

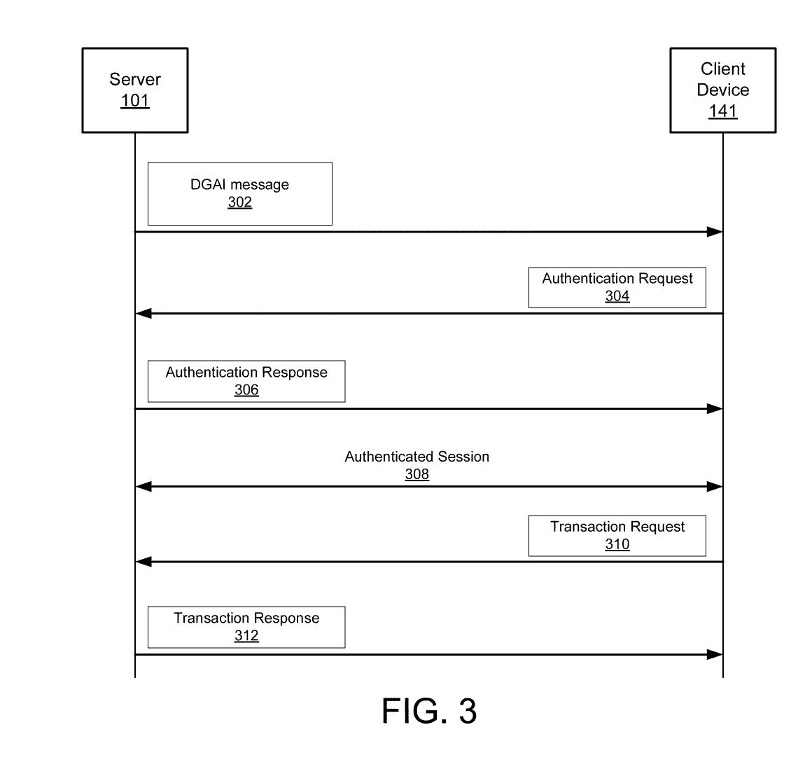

FIG. 3 illustrates messages communicated between the server 101 and the client device 141. Periodically (e.g., daily, weekly, monthly, etc.), the server 101 may communicate a DGAI message 302 that includes the DGAI statement 200 to the client device 141 via the network 131, such as the Internet. The DGAI message 302 may be, for example, an email including the DGAI statement 200 attached as a PDF document, by Adobe®. The DGAI statement 200 may also be accessible through an online banking website provided by the server 101.

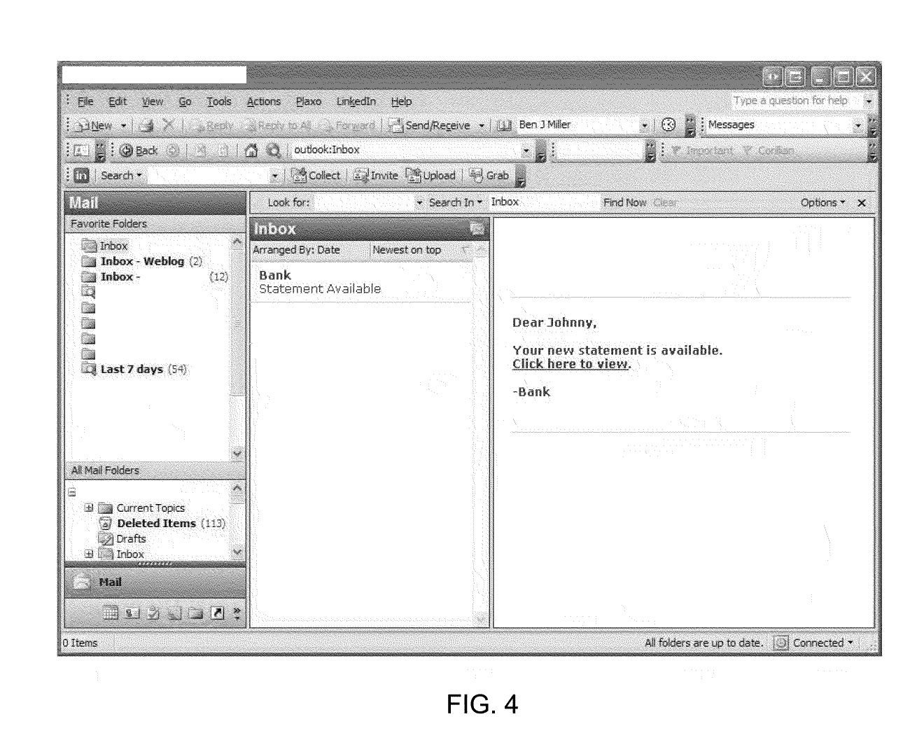

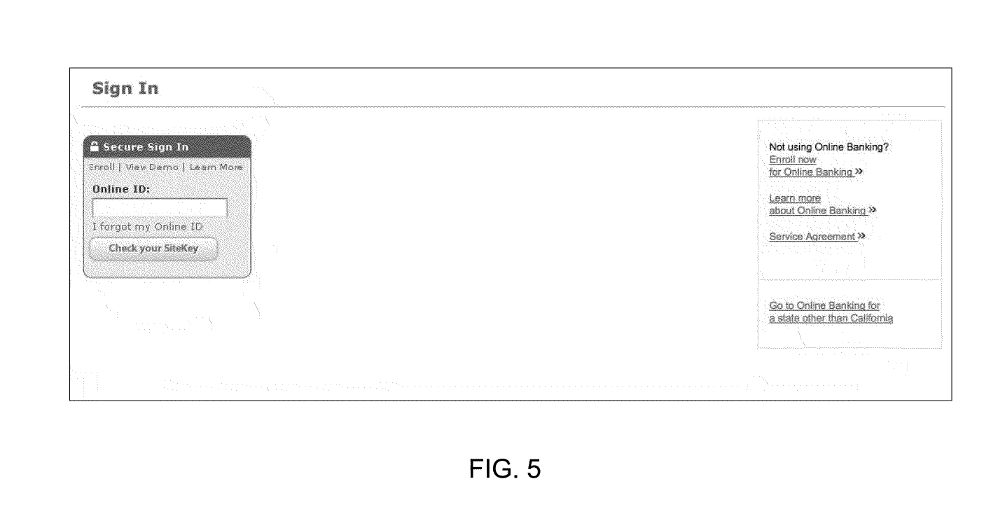

The client device 141 may receive and present the DGAI message 302 in an interface to inform the user that the DGAI statement 200 is available, as shown in FIG. 4. To maintain security of the information in the DGAI statement 200, the client device 141 may require authentication of the user prior to granting access to the DGAI statement 200. For example, the DGAI message 302 may include a hyperlink to a webpage. In response to user selection of the DGAI message 302, the client device 141 may query the server 101 for an authentication webpage, as shown in FIG. 5, to initiate user authentication by prompting the user to enter a user name, such as, for example, an online identifier (ID).

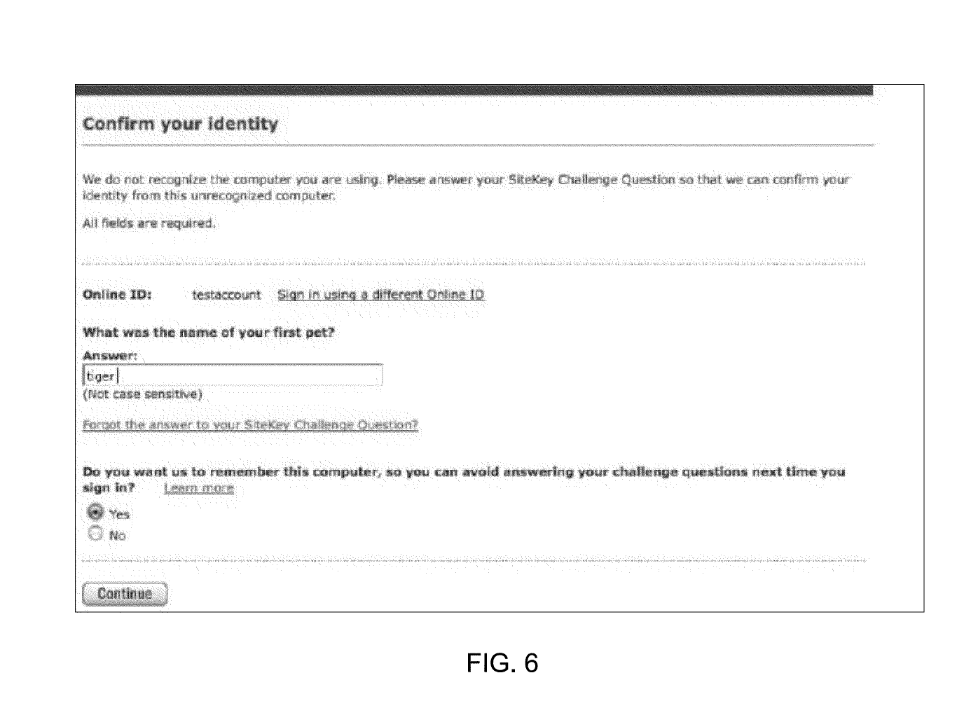

During authentication, the computer server 101 may determine whether the user has previously accessed a DGAI statement 200 using a particular client device 141. For example, the server 101 may assign a unique identifier to each client device 141 associated with a particular user name. If the user has previously accessed the DGAI statement 200 using a particular client device 141, the server 101 may not further prompt the user to answer one or more challenges questions (e.g., mother's maiden name, etc.). If the client device 141 is unrecognized, the server 101 may communicate an identity confirmation webpage, as shown in FIG. 6.

When the challenge question is answered correctly or if the unique identifier is recognized, the computer server 101 may cause the client device 141 to display the user's SiteKey image, such as SITEKEY™ by BANK OF AMERICA™. The SiteKey image may be a picture selected by the user when signing up for an account associated with the DGAI statement 200. If the user determines that the SiteKey image is correct, the user may input their password. The client device 141 may communicate an authentication request 304 that includes the password to the server 101 (see also FIG. 3). In reply, the server 101 may communicate an authentication response 306 either instructing the client device 141 to inform the user that authentication was unsuccessful or providing authentication information or an authentication key to the client device 141 to decrypt the DGAI statement 200. The client device 141 may communicate the authentication information or encrypt data using the authentication key when communicating with the server 101 in the authenticated session 308. Other manners of user authentication may also be used.

Upon successful user authentication, the server 101 may establish an authenticated session 308 with the client device 141 to permit the user to conduct transactions using the DGAI statement 200. Because the user already has been authenticated when accessing the DGAI statement 200, the server 101 might not require further user authentication to conduct the transactions until a user ends the authenticated session. For example, the client device 141 may use the authentication key, provided to decrypt the DGAI statement 200, to encrypt messages sent to the server 101. The client device 141 may encrypt information that is to be communicated to the server 101 using the authentication key to generate a transaction request 310. In other examples, the client device 141 may communicate authentication information in a transaction request 310 instead of or in addition to encrypting with an authentication key. Example transactions that may be requested include bill payment, balance transfers, and enrolling in marketing offers, as further described below. The DGAI statement 200 may include links associated with each transaction permitting the client device 141 to request additional information or to sign up for offers. The server 101 may decrypt and process the transaction request 310, and may encrypt a transaction response 312 using the authentication key that is communicated to the client device 141. The transaction response 312 may identify whether the server 101 executed the transaction or may indicate that the server 101 was unable to execute the transaction. Examples of conducting transactions using the DGAI statement 200 are provided below.

Referring again to FIGS. 2A-B, these figures illustrate an example DGAI statement 200, where FIG. 2A illustrates a first page and FIG. 2B illustrates a second page of the DGAI statement 200. The DGAI statement 200 may list previous payments and credits, purchases, previously completed transactions during a billing cycle. A purchase field 206, for example, may identify a transaction date, a posting date, a description of a purchase, a reference number to uniquely identify the purchase, and an account number used to make the purchase. The user may select one or more of the purchase fields 206 in the DGAI statement 200, and the purchase fields 206 may be associated with a hyperlink to request additional information on the selected purchase(s). In an example, the user may determine that a charge looks suspicious and want to further investigate. The user may select the purchase field 206 and, in response, the client device 141 may include information on the purchase (e.g., a reference number) in a transaction request 310. The computer server 101 may receive and process the transaction request 310. The computer server 101 may communicate a transaction response 312 to the client device 141 including a webpage providing supplemental information on the previously completed transaction. The webpage may include links to an authenticated website provided by the financial institution providing a webpage with forms for a user to complete to dispute a charge.

The DGAI statement 200 may include multiple transaction fields 202, 204, 208, 210, and 212 permitting the user to request transactions be performed using their account or to sign up for an offer. In an example, transaction field 202 may provide bill payment for their account, transaction fields 204, 208, and 212 may permit the user to sign up for offers provided by the financial institution or other entity, and transaction field 210 may permit the user to access rewards for using their account. Each of the fields may be associated with a link to request a webpage to obtain additional information or to sign up for the offer. A link may be a hyperlink or other information to establish a connection with an information provider, such as the server 101 or other entity.

To pay a bill, the user may input information into the transaction field 202. In this example, the DGAI statement 200 may be a credit card statement that permits a user to pay some or all of a credit card balance. The transaction field 202 may permit the user to select a ‘Pay From’ account using a drop down menu to select an account to debit (e.g., checking account, savings account, money market account, etc.), a payment amount (e.g., minimum due, new balance, etc.), and a “payment date” to select the date on which payment is applied. Upon entering the desired information, the user may select the select a “schedule payment” icon in the transaction field 202.

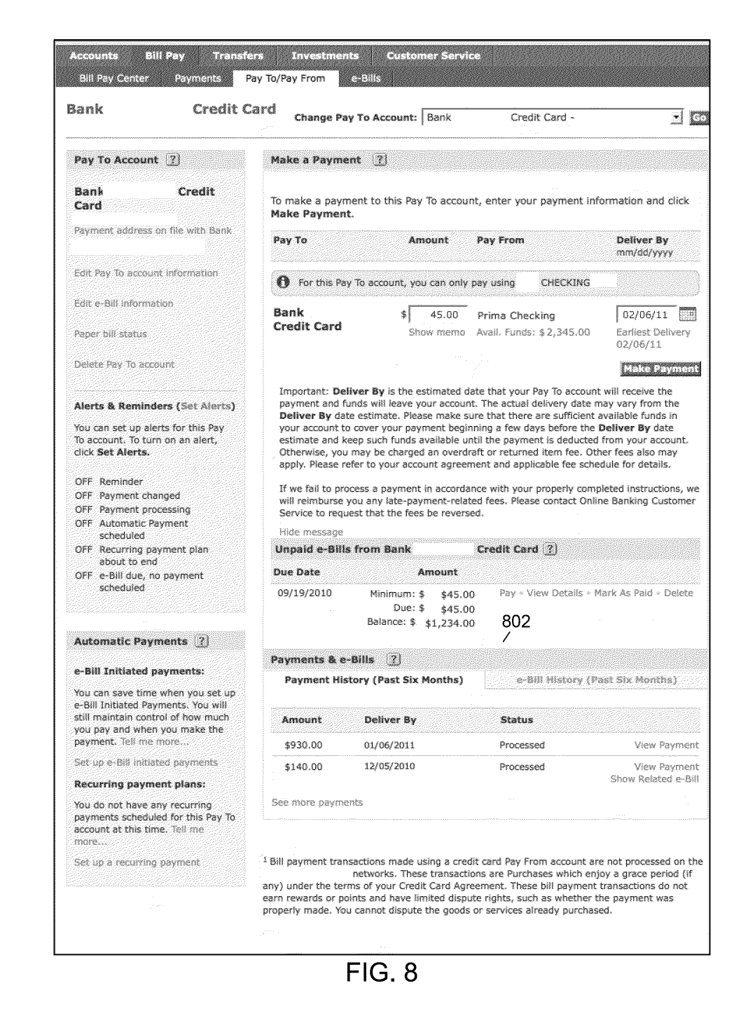

In response, the client device 141 may encrypt the user entered payment information (i.e., amount, payment date, etc.) with the authentication key to generate a transaction request 310 (see also FIG. 3). The client device may communicate the transaction request 310 to the server 101 for processing. The server 101 may process the transaction request 310 and generate a transaction response 312 in reply indicating whether the transaction was executed as requested. The transaction response 312 may be a webpage, for example, as shown in FIG. 8. If successfully executed, a payment field 802 of the webpage may reflect that payment was scheduled successfully. If unsuccessful, the webpage may indicate the reason (e.g., insufficient funds, attempted payment from a closed account, failure to properly communicate with server 101, or other error, etc.).

Referring again to FIGS. 2A-B, the DGAI statement 200 may also present the user with offers provided by a financial institution or other entity. Transaction fields 204, 208, and 212 correspond to example offers. For example, transaction field 208 corresponds to an offer for satellite television from a competing satellite provider, and transaction field 212 corresponds to a balance transfer offer from the financial institution. The user may select an offer of interest.

For instance, the user may select the field 208 containing the offer for a competing service. When creating the DGAI statement 200, the server 101 may process payments made during the previous billing cycle (e.g., month) to determine that the user pays for satellite television service each month using their account. A competitor may purchase advertisement space within the DGAI statement 200 whenever the server 101 identifies that a customer has made purchase for a particular service (e.g., satellite television) from a competing provider. The server 101 may include the field 208 in the DGAI statement 200 to provide an offer from the advertiser for user selection.

Once selected, the client device 141 may request a webpage corresponding to the selected offer from the server 101 and present the webpage to the user. For instance, the field 208 may be associated with a uniform resource locator (URL) of a website to request upon user selection. The field 208 may also direct the client device 141 to a third party server, instead of server 101, that provides the webpage. The user may input information into the webpage to sign up for the offer.

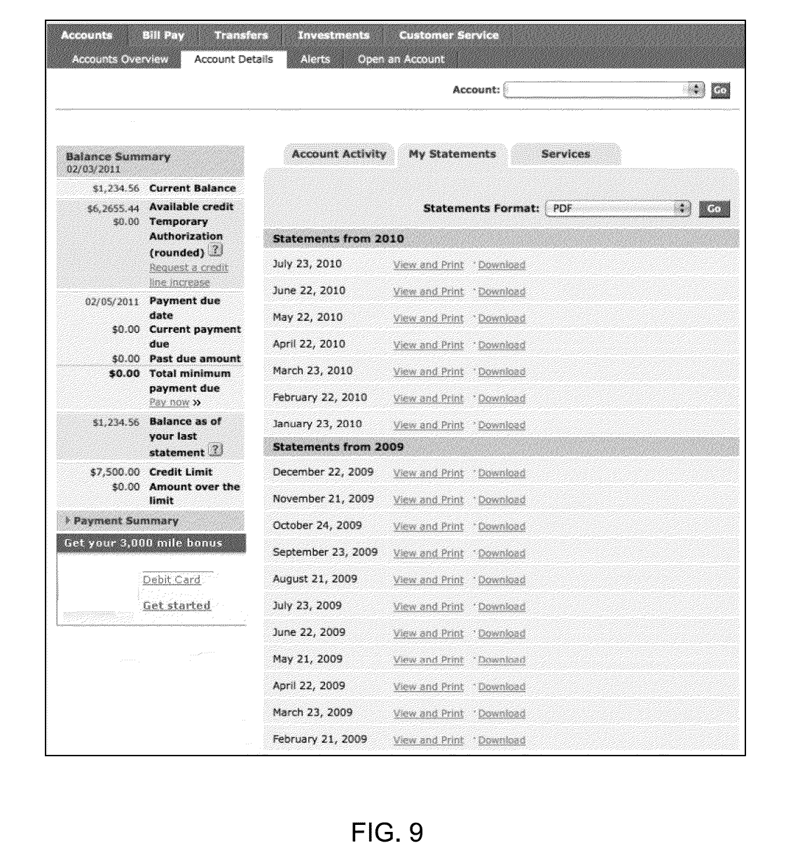

The field 208 also may be associated with an expiration date for the offer. If the expired, the client device 141 may provide access to a webpage indicating that the offer is no longer available and may direct the user to one or more other offers that may be of interest to the user. FIG. 9, for example, permits a user to access old bank statements that may contain offers that have expired. The field 208, for instance, may be associated with a second URL to be used after the offer expiration date. The second URL may direct the client device 141 to request information from the server 101 or from a third party server. The server 101 may process the user's most recent purchase data and provide a webpage with one or more current offers that conform to the offer selected in field 208, as well as informing the user that the previous offer has expired.

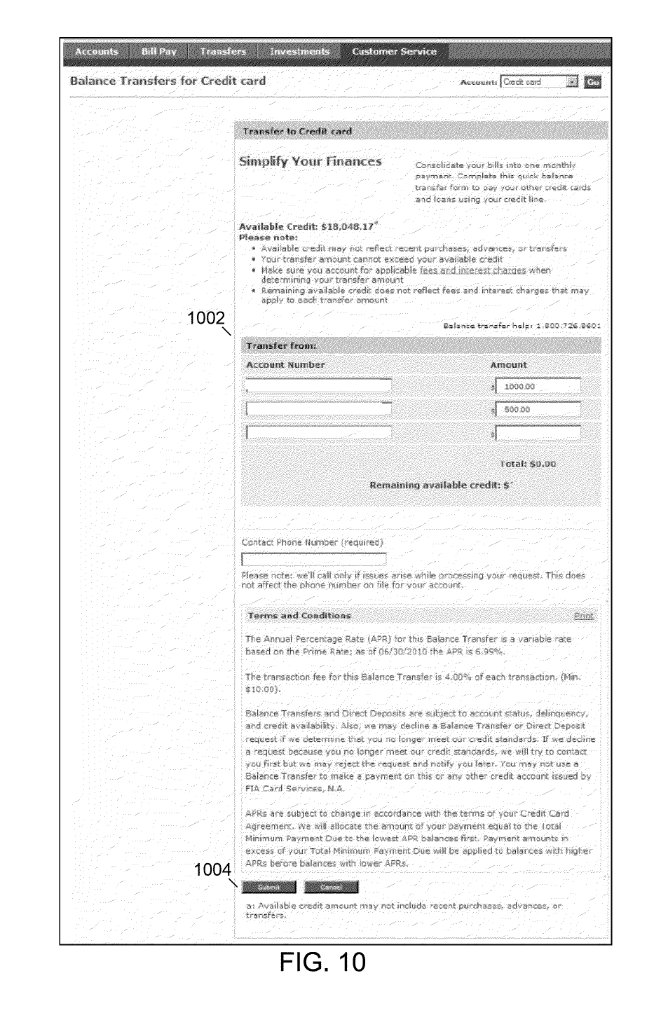

Referring to FIG. 2B, the DGAI statement 200 may provide the user with a field 212 that may include advertisements for cross-selling of other products available from the financial institution. For example, the financial institution may provide the user with a credit card account, and the field 212 may identify offers for demand deposit accounts, brokerage services, etc., that are also available from the financial institution. In FIG. 2B, the field 212 corresponds to a balance transfer offer. To make a transfer, the user may manually input an account number of the account from which funds are being transferred and a transfer amount. Also, the DGAI statement 200 may include a pull down menu listing numbers of accounts known to be associated with the user, such as accounts from which the user has previously transferred a balance. Further, the DGAI statement 200 may include a link to an authenticated website so that the user does not have to remember multiple account numbers, as shown in FIG. 10. Because the user was previously authenticated to access the DGAI statement 200, the server 101 may provide the authenticated website to the client device 141 with information about other known user accounts. In FIG. 10, for example, a “Transfer From” field 1002 may auto-populate with known user accounts or the user may manually input the account numbers.

When a user selects to make a balance transfer by selecting “Make Transfer” 214 in FIG. 2B or submit 1004 in FIG. 10, the client device 141 may include the account number and the transfer amount in a transaction request 310 (see also FIG. 3). The client device 141 may encrypt the account number and the amount, along with other information, with the authentication key to form the transaction request 310 for communication to the server 101. The server 101 may process the transaction request 310 and generate a transaction response 312 in reply indicating whether the balance transfer was executed as requested. If successful, the client device 141 may process the transaction response 312 and inform the user that the balance transfer was successful. If the balance transfer is not executed for any reason, the client device 141 may process the transaction response 312 and inform the user accordingly (e.g., low credit score, failure to properly communicate with server 101, or other error, etc.).

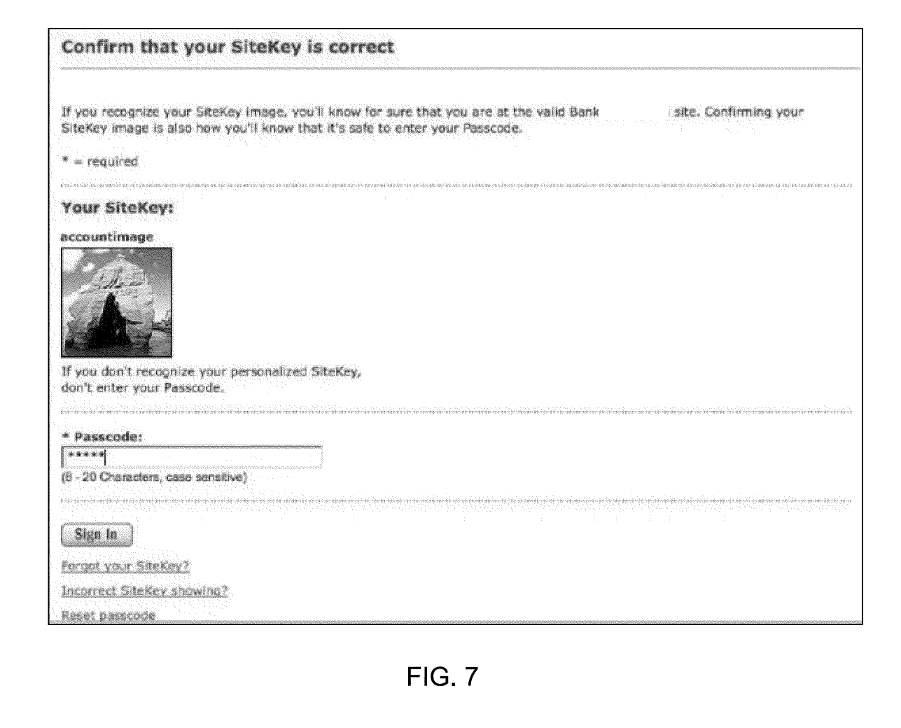

When a user has completed all desired transactions, the user may sign off to terminate the authenticated session 308 (see also FIG. 3). To end the session 308, the client device 141 may generate and communicate a transaction request 310 to the server 101 to end the authenticated session. If the server 101 successfully ends the authenticated session, the client device 141 may process the transaction response 312 and inform the user that the authenticated session has been ended. To perform any further transactions, the user may be re-authenticated as described above with reference to FIGS. 5-7.

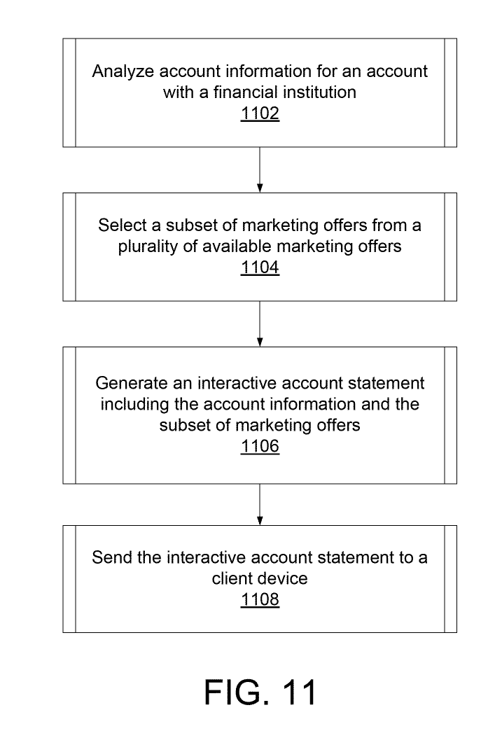

FIG. 11 depicts an example flow diagram for generating a DGAI statement 200. The flow diagram of FIG. 11 may be performed by the computer server 101. In block 1102, the flow diagram may include analyzing account information for an account with a financial institution, where the account is associated with a first customer of the financial institution, and wherein the account information comprises a plurality of purchases made by the first customer using the account. Examples of account information include an account number, purchases made during a current billing cycle and/or during previous billing cycles, or other information shown in FIGS. 2A-2B. In block 1104, the flow diagram may include selecting a subset of marketing offers from a plurality of available marketing offers, based on the plurality of purchases. In block 1106, the flow diagram may include generating an interactive account statement for the customer, the account statement comprising the account information and the subset of marketing offers, wherein each marketing offer in the subset of marketing offers is hyperlinked in the interactive account statement to additional information corresponding to that offer. For example, each offer may be hyperlinked to a webpage to sign up for or to receive additional information on an offer. In block 1108, the flow diagram may include sending the interactive account statement to a client device associated with the customer. The flow diagram of FIG. 11 may then end. It is noted that the flow diagram of FIG. 11 may be repeated one or more times to generate interactive account statements for multiple customers, and at least some of the offers in each interactive account statement may differ.

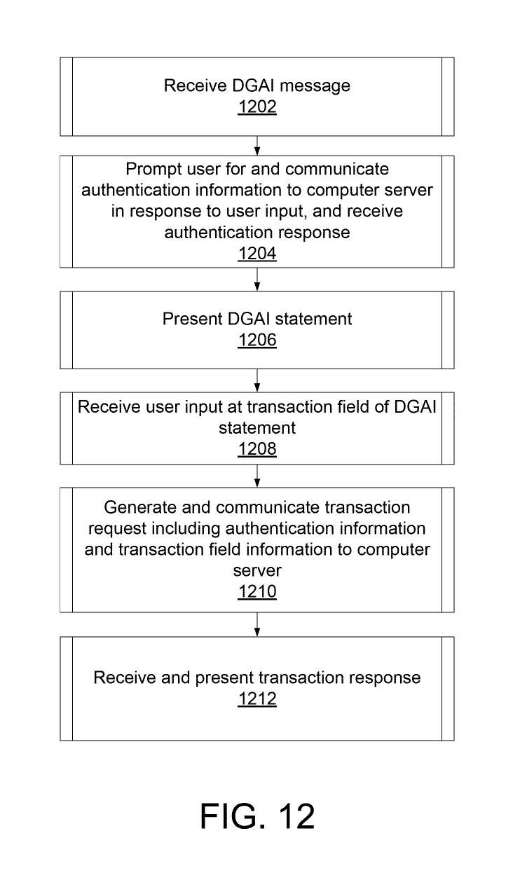

FIG. 12 depicts an example flow diagram for processing a transaction using a dynamically generated interactive account statement. The flow diagram of FIG. 12 may be performed by the client device 141. In block 1202, the flow diagram may include receiving an interactive account message including an interactive account statement 200. In block 1204, the flow diagram may include prompting a user for identifier information in response to a user instructing the client device 141 to open the interactive account statement 200, communicating an authentication request 304 to a computer server 101, and receiving an authentication response 306 from the computer server 101. In block 1206, the flow diagram may include presenting the interactive account statement 200 to the user. In block 1208, the flow diagram may include receiving user input at one or more of the transaction fields 202-212 of the interactive account statement 200. In block 1210, the flow diagram may include generating and communicating a transaction request 310 to the computer server 101 that includes authentication information of the user and the information from one or more of the transaction fields 202-212. In block 1212, the flow diagram may include receiving and presenting a transaction response 312 at the client device 141 to the user. The flow diagram of FIG. 12 may then end.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices. The computer-executable instructions may be stored on a computer readable media, such as, but not limited to, a hard disk, a floppy disk, a flash drive, or other tangible computer readable media and memories.

Aspects of the present disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional.

What is claimed is:

1. A method comprising:
analyzing account information for an account with a financial institution, where the account is associated with a first customer of the financial institution, and wherein the account information comprises a plurality of purchases made by the first customer using the account;
selecting, by a processor, a subset of marketing offers from a plurality of available marketing offers, based on the plurality of purchases;
generating an interactive account statement for the customer, said account statement comprising the account information and the subset of marketing offers, wherein each marketing offer in the subset of marketing offers is hyperlinked in the interactive account statement to additional information corresponding to that offer; and
sending the interactive account statement to a client device associated with the customer.

2. The method of claim 1, further comprising
analyzing second account information for a second account with the financial institution, where the second account is associated with a second customer of the financial institution, and wherein the account information comprises a second plurality of purchases made by the second customer using the second account;
selecting a second subset of marketing offers from the plurality of available marketing offers, based on the second plurality of purchases;
generating a second interactive account statement for the second customer, said second account statement comprising the second account information and the second subset of marketing offers, wherein each marketing offer in the second subset of marketing offers is hyperlinked in the second interactive account statement to additional information corresponding to that offer, wherein the second subset of marketing offers is different from the first subset of marketing offers; and
sending the second interactive account statement to a second client device associated with the second customer.

3. The method of claim 1, further comprising analyzing the purchases over a predetermined period of time.

4. The method of claim 3, wherein the analyzing of the purchases comprises identifying a product or service purchased at semi-regular periodic intervals.

5. The method of claim 4, wherein at least one of the subset of marketing offers is included in the interactive account statement due to a current time corresponding to a next instance of the semi-regular periodic interval.

6. The method of claim 3, wherein the analyzing of the purchases comprises decreasing a weight assigned to a first of the purchases based on a time since the first purchase exceeding a threshold amount of time.

7. The method of claim 1, wherein the selecting of the subset of the marketing offers is further based on a marketed product being related to at least one of the purchases.

8. The method of claim 1, wherein a first offer of the subset of the marketing offers corresponds to a first link for use prior to an expiration date and a second link for use after the expiration date.

9. A computer readable medium storing instructions that, when executed, cause an apparatus at least to perform:
analyzing account information for an account with a financial institution, where the account is associated with a first customer of the financial institution, and wherein the account information comprises a plurality of purchases made by the first customer using the account;
selecting a subset of marketing offers from a plurality of available marketing offers, based on the plurality of purchases;
generating an interactive account statement for the customer, said account statement comprising the account information and the subset of marketing offers, wherein each marketing offer in the subset of marketing offers is hyperlinked in the interactive account statement to additional information corresponding to that offer; and
sending the interactive account statement to a client device associated with the customer.

10. The computer readable medium of claim 9, wherein the instructions, when executed, cause the apparatus to perform:
analyzing second account information for a second account with the financial institution, where the second account is associated with a second customer of the financial institution, and wherein the account information comprises a second plurality of purchases made by the second customer using the second account;
selecting a second subset of marketing offers from the plurality of available marketing offers, based on the second plurality of purchases;
generating a second interactive account statement for the second customer, said second account statement comprising the second account information and the second subset of marketing offers, wherein each marketing offer in the second subset of marketing offers is hyperlinked in the second interactive account statement to additional information corresponding to that offer; and
sending the second interactive account statement to a second client device associated with the second customer, wherein the second subset of marketing offers is different from the first subset of marketing offers.

11. The computer readable medium of claim 9, wherein the instructions, when executed, cause the apparatus to analyze the purchases over a predetermined period of time.

12. The computer readable medium of claim 11, wherein the analyzing of the purchases comprises identifying a product or service purchased at semi-regular periodic intervals.

13. The computer readable medium of claim 12, wherein at least one of the subset of marketing offers is included in the interactive account statement due to a current time corresponding to a next instance of the semi-regular periodic interval.

14. The computer readable medium of claim 11, wherein the analyzing of the purchases comprises decreasing a weight assigned to a first of the purchases based on a time since the first purchase exceeding a threshold amount of time.

15. The computer readable medium of claim 9, wherein the selecting of the subset of the marketing offers is further based on a marketed product being related to at least one of the purchases.

16. The computer readable medium of claim 9, wherein a first offer of the subset of marketing offers corresponds to a first link for use prior to an expiration date and a second link for use after the expiration date.

17. An apparatus comprising:
a processor; and
a memory storing instructions that, when executed, cause the apparatus at least to perform:
analyzing account information for an account with a financial institution, where the account is associated with a first customer of the financial institution, and wherein the account information comprises a plurality of purchases made by the first customer using the account;
selecting a subset of marketing offers from a plurality of available marketing offers, based on the plurality of purchases;
generating an interactive account statement for the customer, said account statement comprising the account information and the subset of marketing offers, wherein each marketing offer in the subset of marketing offers is hyperlinked in the interactive account statement to additional information corresponding to that offer; and
sending the interactive account statement to a client device associated with the customer.

18. The apparatus of claim 17, wherein the instructions, when executed, cause the apparatus to analyze the purchases over a predetermined period of time, wherein the analyzing of the purchases comprises identifying a product or service purchased at semi-regular periodic intervals, and wherein at least one of the marketing offers is included in the interactive account statement due to a current time corresponding to a next instance of the semi-regular periodic interval.

19. The apparatus of claim 17, wherein the selecting of the subset of marketing offers is further based on a marketed product being related to at least one of the purchases.

20. The apparatus of claim 17, wherein a first offer of the subset of marketing offers corresponds to a first link for use prior to an expiration date and a second link for use after the expiration date.
